(19) United States
(12) Patent Application Publication
(10) Pub. No.: US 2007/0235471 A1
(43) Pub. Date: Oct. 11, 2007

(54) Back pack applicator for coatings or sealants

(76) Inventor: Marty Edward Radermacher, Mareitta, GA (US)

Correspondence Address: Marty Edward Radermacher, 2692 South Arbor Dr., Marietta, GA, 30066, US

(21) Appl. No.: 11/728,916

(22) Filed: Mar. 27, 2007

Related U.S. Application Data
(60) Provisional application No. 60/767,424, filed on Mar. 27, 2006.

(51) Int. Cl. B65D 35/28; B65D 35/56; B67D 5/64

(52) U.S. Cl. 222/95; 222/175; 222/105; 222/386.5

(57) ABSTRACT

A machine for delivering liquid coating or sealant from a flexible walled package to an applicator, package fitment will accommodate sealing of compressed gas in canister and seal the product in pouch for dispensing, a light weight pressure rated canister for the package and compressed gas can be added external to the package and internal to the canister for application, a compressor for delivering compressed gas to the canister, a safety relief valve set below canister rated pressure, an adjustable pressure switch to control the on/off function of the compressor automatically, a dispensing tube that is flexible and sized to handle the required flow rate with minimal pressure drop and convenient in length for application, an adjustable valve with an operator button on applicator handle for optimized product flow during application, a back pack harness or side harness to hold the canister for mobility and hands free operation.

### CROSS REFERENCE TO RELATED APPLICATIONS

This application is based on provisional application Ser. No. 60/767,424, filed on Mar. 27, 2006.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

Based on previous patents and published patent application, paint pouches utilizing pressure to drive the paint therefrom are well known. Several of these references teach heat sealed bags with fittings heat-sealed therein, wherein the bag is collapsed by external pressure. The external pressure is taught to be provided by a clamping means, pressurized gas or gas generation either against a diaphragm, bladder or bag.

U.S. Pat. No. 5,169,037 to Davis et al. appears to disclose some of the essential elements of this invention. Although Davis et al. '037 teaches a pouch within a rigid container, wherein the pouch is compressed by external air pressure, none of the previous patents or applications teaches the utilization of a micro-compressor to provide air pressure. None of the previous patents or applications teaches the orientation of the discharge fitment on the bottom of canister during dispensing and application. The fitment with corresponding seal arrangement is not shown in previous patents or applications with quick disconnect and shut-off valve for clean easy set-up.

More over U.S. Pat. No. 4,513,884 to Magid et al. discloses a refillable dispensing pouch made by heat-sealing laminated foils, wherein pressure with the bag expels product from a container and wherein the pressure is provided by a gas generating mixture of two components. This concept lacks a micro-compressor for compressed gas generation and is not easy to load or clean.

As further noted U.S. Pat. No. 3,418,054 to Kirch et al. teaches a backpack container for paint, wherein paint is driven from the container by air pressure, and wherein the air pressure is provided by a hand pump. However, Kirch '054 lacks a sealed internal paint pouch.

Once again, there is nothing in the above-reference art that would teach the utilization of a micro-compressor to provide the air to collapse the bag. All prior art utilizes gas generation for collapsing pouch or expanding pouch.

More over, the flexible walled container pouch used is easy to load and is disposable. The pouch fitment with corresponding canister and product seal capabilities makes it easy to connect to the coatings or sealant applicator.

More specifically, the orientation of the pouch with the fitment and corresponding dispensing process on the bottom provides an effective and complete removal of all coating or sealant product flowing out the bottom.

### BRIEF SUMMARY OF THE INVENTION

The primary object of the invention is an apparatus and method for applying coating or sealant virtually free of mess.

Another object of the invention is an apparatus and method that is easy to use and easy to clean.

Another object of the invention is an apparatus and method that substantially reduces the time required for the application of coating or sealant.

A further object of the invention is a reduction in coating or sealant container waste and residual product waste to landfill.

Yet another object of the invention is an apparatus and method of resealing unused coating or sealant product virtually free of air for more effective storage with reduced dry coating or sealant in container.

Still yet another object of the invention is an apparatus and method for reducing the cleanup time required for applying coating or sealant.

Another object of the invention is a back pack harness to hold the canister and accessories which allows mobility and hands free operation for applying the coating or sealant.

Another object of the invention is a light weight back pack that is easy to use and handle for applying coating or sealant.

A further object of the invention is an automatic dispensing feature so you can apply coating or sealant at any desired rate.

Yet another object of the invention is a container for coating or sealant that is easier to handle during the manufacturing filling process and weighs less than the container used currently.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for delivering liquid coating or sealant to an applicator comprising: a flexible walled package containing liquid coating or sealant, a flexible walled package containing liquid coating or sealant with a fitment which will accommodate the sealing of compressed gas in a canister and seal the product in the pouch for dispensing, a light weight pressure rated canister to house the flexible walled package for coating or sealant and compressed gas can be added external to the flexible walled package and internal to the canister for application, a compressor for delivering compressed gas to the canister for application of coating or sealant, a safety relief valve set below canister rated pressure, an adjustable pressure switch or similar electromechanical device to control the on/off or modulating function of the compressor automatically, a dispensing tube or hose that is flexible and sized to handle the required flow rate with minimal pressure drop and convenient in length as to not hinder the applicators movement, an adjustable valve with an operator button, trigger or similar squeeze handle on applicator handle for optimized product flow during application, and a back pack style harness or similar side harness to hold the canister and accessories to provide mobility and hands free operation for applying the coating or sealant.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DRAWING DESCRIPTION

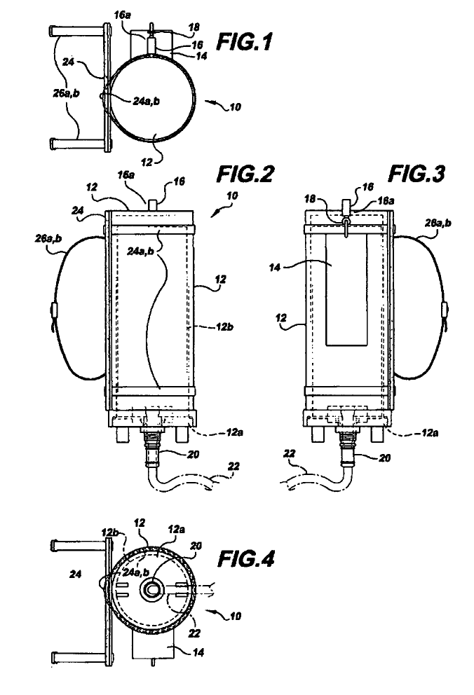

FIG. 1: is a top plan view of the overall invention 10

FIG. 2: is a right side elevation view of the overall invention 10

FIG. 3: is a left side elevation view of the overall invention 10

FIG. 4: is a bottom plan view of the overall invention 10

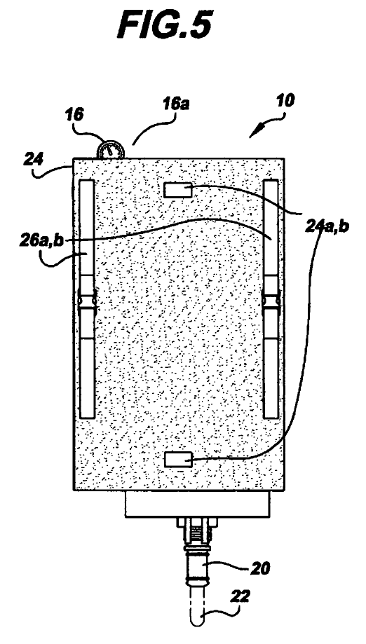

FIG. 5: is a front elevation view of the overall invention 10

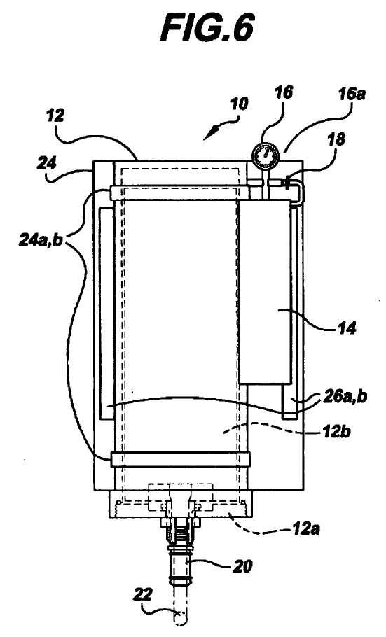

FIG. 6: is a rear elevation view of the overall invention 10

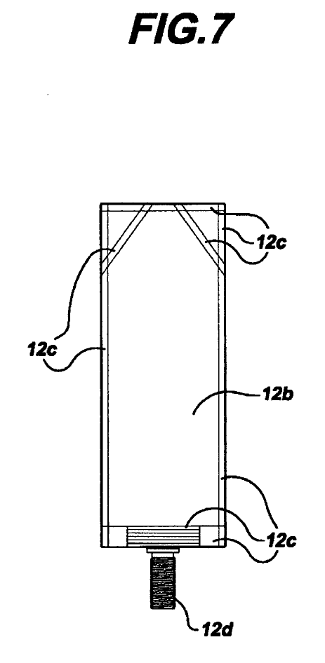

FIG. 7: is a plan view of the pouch or flexible walled package 10

### NUMBER DESCRIPTION LIST

10: is the overall invention of a rechargeable micro-compressor to pressurize the exterior of a pouch and force coatings or sealant to the applicator. The coating or sealant would be filled in a pouch other flexible walled package 12b with a screw on cap or other closure 12a and self closing valve 20 in a canister 12. Air would be fed into the canister up to 150 psi. The air fed into the canister would compress the exterior of the pouch 12b which would allow the product in the package to be fed into an applicator such as a roller for paint or dispensing fitment for caulk thru dispensing tube 22.
12: is the canister.
12a: is the cap on the canister.
12b: is the pouch or flexible walled package that holds the coating or sealant.
12c: is the pouch or flexible walled package sealed seams.
12d: is the pouch or flexible walled package closure fitment.
14: is the rechargeable micro-compressor.
16: is the air pressure gauge.
16a: is a vent/safety valve.
18: is the air pressure switch
20: is the self closing valve fitment for attaching dispensing tube 22.
22: is the dispensing tube.
24: is the padded backpack harness.
24a,b: are the padded harness straps that attach the harness 24 to the canister 12.
26a,b: are the back pack holder straps.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### BACKGROUND OF THE PREFERRED EMBODIMENT

This application is a continuation-in-part-of pending U.S. Ser. No. 60/767,424 filed on Mar. 27, 2006 entitled “Back Pack Applicator”.

This invention relates generally to the field of coating and sealant application and more specifically to a machine for delivering liquid coating or sealant to an applicator.

Utilizing the rechargeable micro-compressor to provide air as the motive force to collapse the pouch (flexible walled container) is made easy with the rechargeable NiCad battery. This light weight compressor provides the volume and pressure required to effectively convey the coating or sealant from the pouch to the applicator at the desired rates.

The pouch with specifically designed fitments that utilize the quick shutoff valves make the machine for delivering liquid coating or sealant to an applicator simple to use and easy to clean.

### FIELD OF THE INVENTION

This invention is directed to the application of coating or sealant on a surface. In particular, the present invention is directed to the utilization of a unique flexible walled package, pre-filled, being loaded into an applicator and dispensed using a rechargeable micro-compressor to collapse the package under pressure.

### PRINCIPAL INVENTION AND PREFERRED EMBODIMENTS

A fitment or device on the flexible walled package containing liquid coating or sealant which will accommodate the sealing of compressed gas in a canister and seal the product in the package for dispensing and allow for the connection to a quick connect shutoff valve.

A light weight pressure rated canister to house the said flexible walled package filled with coating or sealant and compressed gas can be added external to the said flexible walled package and internal to the said canister for bottom sealed dispensing to applicator.

A rechargeable micro-compressor for delivering compressed gas to the said canister for application of coating or sealant.

A safety relief valve set below said canister rated pressure.

An adjustable pressure switch or similar electro-mechanical device to control the on/off or modulating function of the said compressor automatically.

A dispensing tube or hose with quick connect shutoff valve that is flexible and sized to handle the required flow rate with minimal pressure drop and convenient in length as to not hinder the applicators movement.

An adjustable valve with an operator button, trigger or similar squeeze handle on applicator handle for optimized product flow during application.

A back pack style harness or similar side harness to hold the canister and accessories to provide mobility and hands free operation for applying the coating or sealant.

A stand for said canister with wheels or feet, if wheels positioned for easy transport while tipping forward with handle.

### OPERATION OF THE INVENTION

Referring first to FIGS. 1 to 7 and numbered description list 12 to 26b; A flexible walled package 12b having an internal volume of approximately 1 to 2 liters containing liquid coating or sealant with a fitment 12d which will accommodate the sealing of compressed gas in a canister 12 and seal the product in the package 12b for dispensing is purchased already filled. The package 12b is loaded into the light weight pressure rated canister 12 to house the package filled with coating or sealant by removing the end cover 12a. The package 12b is sealed to the canister 12 by utilizing the package closure fitment 12d. The canister cover 12a is closed and sealed. The dispensing tube 22 or hose which is connected to the applicator is connected to the package via the quick connects with shut-off valves 20. The adjustable pressure switch 18 or similar electromechanical device to control the on/off or modulating function of the compressor automatically is set to required set point. The operator would then dawn the back pack style harness 24 or similar side harness to hold the canister 12 and accessories to provide mobility and hands free operation for applying the coating or sealant. The rechargeable micro-compressor 14 is turned on for product application. The adjustable valve with an operator button, trigger or similar squeeze handle on applicator handle for optimized product flow during application is adjusted accordingly for optimized application. When the product package 12b is empty the product will stop flowing. Air is relieved from canister 12 via the vent/safety relief valve 16a. After air is relieved the empty package 12b is removed and a filled package 12b is loaded for application.

Alternative methods include but not limited to;

a rechargeable gas canister to supply the compressed gas;
a paristaltic pump producing the motive force to dispense the liquid coating or sealant;
a flexible walled package containing liquid coating or sealant with or without a fitment dispensing liquid coating or sealant;

### ADVANTAGES OVER PRIOR ART

The advantages over prior art comprising:
an apparatus and method for applying coating or sealant virtually free of mess;
an apparatus and method that is easy to use and easy to clean;
an apparatus and method that substantially reduces the time required for the application of coating or sealant;
a reduction in coating or sealant container and residual product waste to landfill;
an apparatus and method of resealing unused coating or sealant product virtually free of air for more effective storage with reduced dry coating or sealant in container;
an apparatus and method for reducing the cleanup time required for applying coating or sealant;
a back pack harness to hold the canister and accessories which allows mobility and hands free operation for applying the coating or sealant;
a light weight back pack that is easy to use and handle for applying coating or sealant;
an automatic dispensing feature so you can apply coating or sealant at any desired rate;
a container for coating or sealant that is easier to handle during the manufacturing filling process and weighs less than the container used currently;

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for delivering liquid coating or sealant to an applicator comprising:
a flexible walled package containing liquid coating or sealant with a fitment which will accommodate the sealing of compressed gas in a canister and seal the product in the pouch for dispensing with quick disconnect feature and shutoff valve capability;
a canister to house said flexible walled package providing means of sealing for said liquid in said container, means of sealing compressed gas in the canister for bottom flow of said liquid for dispensing;

2. The apparatus of claim 1 wherein means for delivering compressed gas to the said canister for pressurizing the interior of said canister and the exterior of said package inside said canister for dispensing said liquid;

3. The apparatus of claim 1 wherein means for safety relief of gas pressure set below said canister rated pressure;

4. The apparatus of claim 1 wherein means for adjusting gas pressure in said canister and to control said compressor automatically;

5. The apparatus of claim 1 wherein means for dispensing said liquid to applicator that is flexible and sized to handle the required flow rate with minimal pressure drop and convenient in length as to not hinder the dispensing of said liquid;

6. The apparatus of claim 1 wherein means for adjusting said liquid dispensing rate through said dispensing means.

7. The apparatus of claim 1 wherein means for wearing back pack which supports said canister and unit to position for comfort purposes on back or person while dispensing or preparing to dispense said liquid.

8. The apparatus of claim 1, wherein a stand for said canister with wheels or feet for transport or stationary support respectively.
